(19) United States
(12) Patent Application Publication
(10) Pub. No.: US 2008/0178107 A1
(43) Pub. Date: Jul. 24, 2008

(54) SYSTEM AND METHOD FOR DYNAMICALLY PRESENTING A DIRECTORY TREE

(75) Inventors: CHUNG-I LEE, Tu-Cheng (TW); HAI-HONG LIN, Shenzhen (CN); KUAN-CHIAO PENG, Tu-Cheng (TW); GANG PENG, Shenzhen (CN); XIN-LING LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/871,167

(22) Filed: Oct. 12, 2007

(30) Foreign Application Priority Data
Jan. 23, 2007 (CN) 200710200100.9

(51) Int. Cl. G06F 3/048

(52) U.S. Cl. 715/769

(57) ABSTRACT

An exemplary method for dynamically presenting a directory tree is disclosed. The method comprises the steps of: providing a database for storing a default directory tree having a plurality of nodes, contents of each node, and logical regulations among the nodes; reading the contents of each node, and putting the contents into each node of the default directory tree; dragging a node from a source address to a destination address; determining whether logical relations between the dragged node and the other nodes accord with the logical regulations; generating a rearranged directory tree if the logical relation between the dragged node and the other nodes accord with the logical regulations, and for putting the contents into corresponding nodes of the rearranged directory tree. A related system is also disclosed.

### BACKGROUND OF THE INVENTION

1. Field of the Invention

The present invention generally relates to a graphical user interface for a computer system, and particularly to a directory tree interface and a method and system for dynamically presenting a directory tree.

2. Description of Related Art

A graphical user interface (GUI) is commonly provided for interactions between a user and a computer. The GUI presents information about hardware devices and software applications of the computer to the user. A common GUI is a directory tree structure. A directory tree allows a programmer or the user to organize the software applications, which have a related subject matter or a common theme. By representing the software applications or the hardware devices as nodes or members in the directory tree, a hierarchical configuration can be used to show logical groupings and relationships between the logical groupings of the software applications or the hardware devices.

While the directory tree structure is useful and quite prevalent within the software applications (i.e., operating systems) of today computers, when the directory tree structure is large, it can become unwieldy for the user to manipulate and understand the directory tree structure. For example, in the process of organizing the directory tree, one of the common operations performed by the user is to drag and drop a node representing a software application from a source address in the directory tree, into a destination address. If the directories and/or subdirectories become large, the directory tree becomes too long. Therefore, the process of organizing a large directory tree is time consuming.

Currently, most directory trees allow a given subdirectory to be hidden from view. This operation tends to be an “all or nothing” (i.e. as in either to display it all or not to display any) choice of views. Where the destination address is in a large subdirectory. The majority of items within the destination subdirectory may be irrelevant to a current task. This takes up valuable display space and necessitates additional manipulation by the user to scroll through irrelevant subdirectory.

Therefore, what is needed is a system and method for dynamically presenting the directory tree, which can drag one node from a source address to a destination address for obtaining a rearranged directory tree conveniently.

### SUMMARY OF THE INVENTION

A system for dynamically presenting a directory tree is provided. The system comprising a database configured for storing a default directory tree with a plurality of node, contents of each node, and logical regulations among the nodes; a content reading unit configured for reading the contents of each node, and for putting the contents into each node of the default directory tree; a node recording unit configured for dragging a node from a source address to a destination address; a determining unit configured for determining whether logical relations between the dragged node and the other nodes accord with the logical regulations; and wherein the content reading unit further configured for generating a rearranged directory tree if the logical relation between the dragged node and the other nodes accord with the logical regulations, and for putting the contents into corresponding nodes of the rearranged directory tree.

Another embodiment of a method for dynamically presenting a directory tree is provided. The method comprises the steps of: providing a database for storing a default directory tree with a plurality of node, contents of each node, and logical regulations among the nodes; reading the contents of each node, and putting the contents into each node of the default directory tree; dragging a node from a source address to a destination address; determining whether logical relations between the dragged node and the other nodes accord with the logical regulations; generating a rearranged directory tree if the logical relation between the dragged node and the other nodes accord with the logical regulations, and for putting the contents into corresponding nodes of the rearranged directory tree.

Other objects, advantages and novel features of the embodiments will be drawn from the following detailed description together with the attached drawings.

### BRIEF DESCRIPTION OF THE DRAWINGS

FIG. 1 is a schematic diagram of a hardware configuration of a system for dynamically presenting a directory tree in accordance with a preferred embodiment;

FIG. 2 is a block diagram of main function modules of a server of the system of FIG. 1;

FIG. 3 is a schematic diagram of a default directory tree and a rearranged directory tree; and

FIG. 4 is a flow chart of a preferred method for dynamically presenting a directory tree by utilizing the system of FIG. 1.

### DETAILED DESCRIPTION OF THE INVENTION

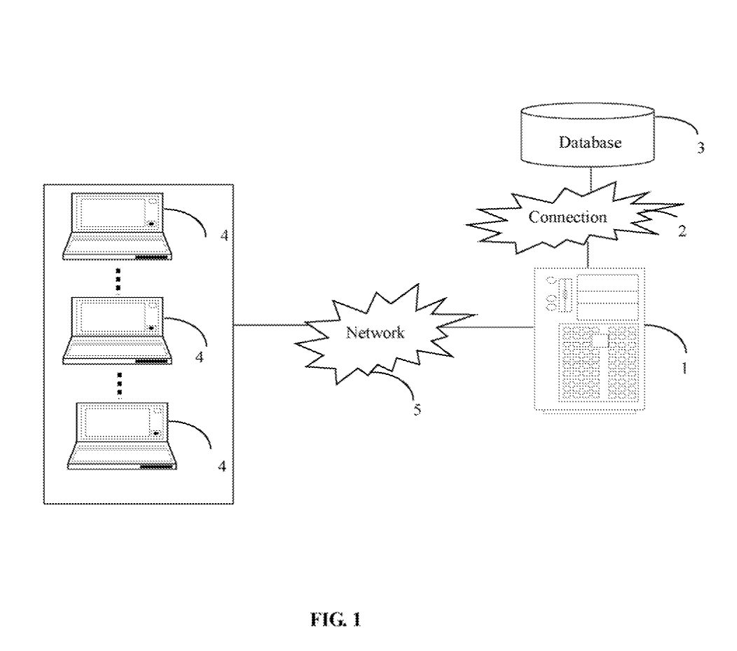

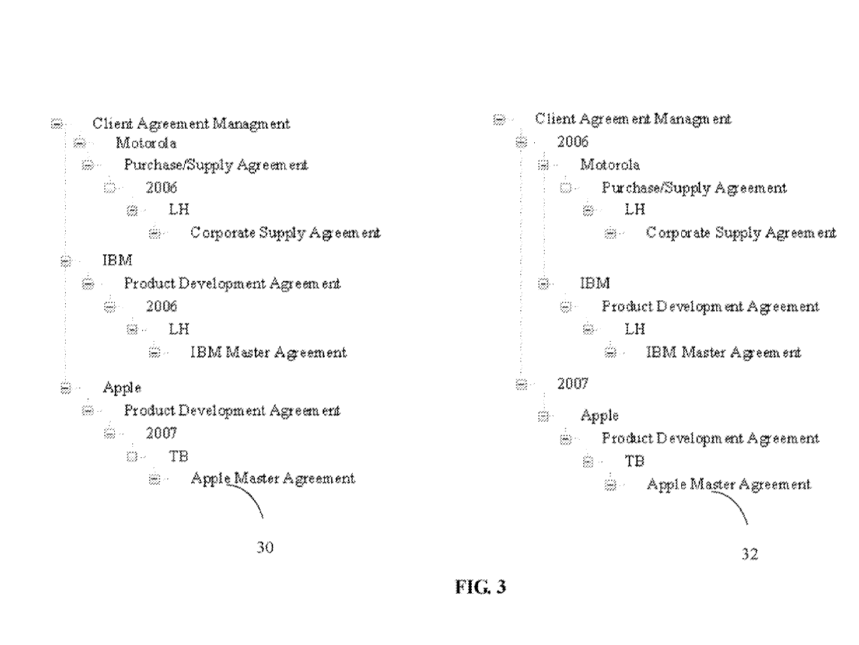

FIG. 1 is a schematic diagram of a hardware configuration of a system for dynamically presenting a directory tree (hereinafter, “the system”) in accordance with a preferred embodiment. The system includes a server 1, and a database 3 connected to the server 1 via a connection 2. A plurality of client computers 4 connects with the server 1 via a network 5. The network 5 may be an intranet, the Internet, or any other suitable electronic communications network. The connection 2 is a database connectivity, such as an Open Database Connectivity (ODBC) or a Java Database Connectivity (JDBC). The database 3 is configured (i.e., structured and arranged) for storing a default directory tree 30 (as shown in FIG. 3) with a plurality of nodes, contents of each node, and logical regulations among the nodes. The logical regulations define the logical relations between each node. For example, if a node named “year”, and another node named “month” in the default directory tree, the logical regulations define that the node named “month” should be a sub-node of the node named “year”.

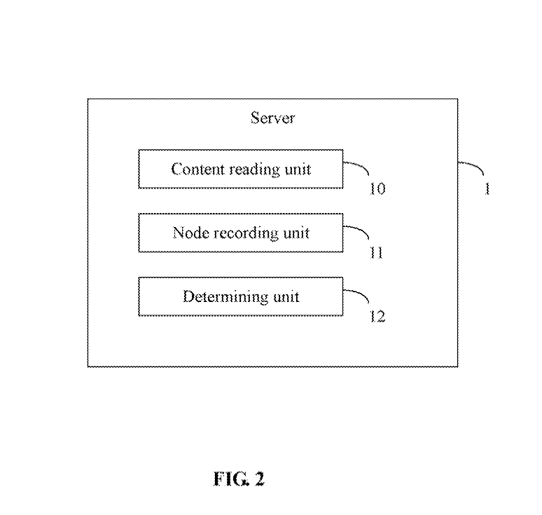

FIG. 2 is a block diagram of main function modules of the server 1. The server 1 installs an application program which includes a content reading unit 10, a node recording unit 11 and a determining unit 12.

The content reading unit 10 is configured for reading the contents of each node, and for putting the contents into each node of the default directory tree in the database 3.

The node recording unit 11 is configured for dragging a node from a source address to a destination address in the default directory 30. For example, in the default directory tree 30, the node recording unit 11 drags a node named “2006” to a destination node named “Motorola”.

The determining unit 12 is configured for determining whether the logical relations between the dragged node and other nodes in the default directory tree 30 accord with the logical regulations. That is, the determining unit 12 determines whether the logical relations between the dragged node named “2006” and the other nodes (i.e., “Motorola”, “IBM”, etc) accord with the logical regulations.

The content reading unit 10 is further configured for generating a rearranged directory tree if the logical relations between the dragged node and other nodes in the default directory tree 30 accord with the logical regulations in the database 3, and putting contents into each node of the rearranged directory tree 32 if the logical relations between the dragged node and other nodes in the default directory tree 30 accord with the logical regulations in the database 3. In FIG. 3, if the logical relations between the dragged node named “2006” and the other nodes (i.e., “Motorola”, “IBM”, etc) destination accord with the logical regulations in the database 3, the content reading unit 10 generates a rearranged directory tree 32, and put corresponding contents into each node of the rearranged directory tree 32.

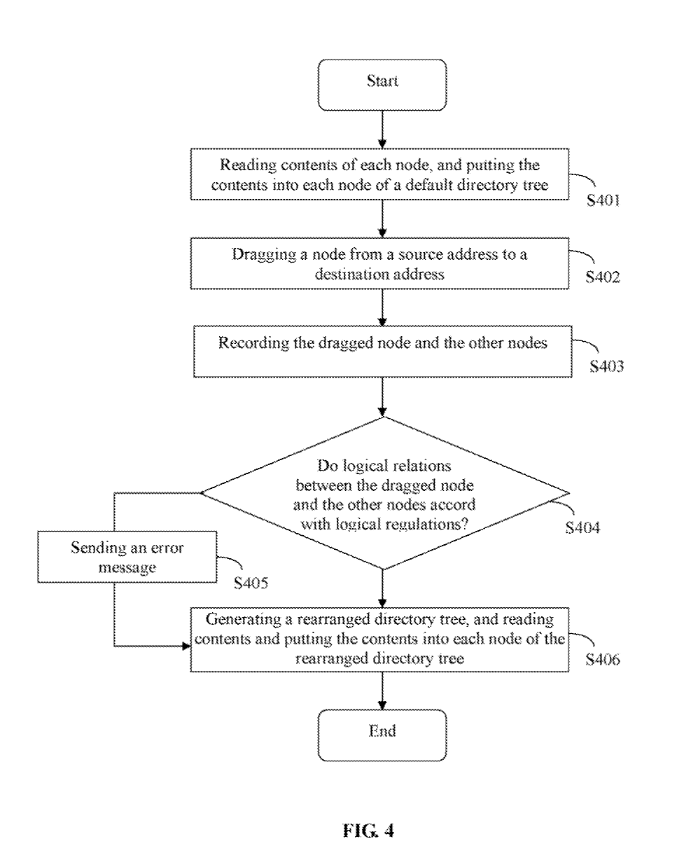

FIG. 4 is a flow chart of a preferred method for dynamically presenting a directory tree. In step S401, the content reading unit 10 reads the contents of each node, and puts the contents into each node of the default directory tree in the database 3. In step S402, the node recording unit 11 drags a node from the source address to the destination address in the default directory 30. For example, in the default directory tree 30, the node recording unit 11 drags a node named “2006” to a destination node named “Motorola”. In step S403, the node recording unit 11 records the dragged node named “2006” and the other nodes (i.e., “Motorola”, “IBM”, etc). In step S404, the determining unit 12 determines whether the logical relations between the dragged node named “2006” and the other nodes accord with the logical regulations in the database 3. That is, the determining unit 12 determines whether the logical relations between the dragged node named “2006” and the other nodes (i.e., “Motorola”, “IBM”, etc) accord with the logical regulations. In step S405, if the logical relations between the dragged node named “2006” and the other nodes do not accord with the logical regulations in the database 3, the determining unit 12 sends the error message to the client computers 4. Otherwise, in step S406, if the logical relations between the dragged node named “2006” and the other nodes accord with the logical regulations, the content reading unit 10 generates a rearranged directory tree 32, and the content reading unit 10 puts corresponding contents of each node into the rearranged directory tree 32.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for dynamically presenting a directory tree, the system comprising:
a database configured for storing a default directory tree with a plurality of node, contents of each node, and logical regulations among the nodes;
a content reading unit configured for reading the contents of each node, and for putting the contents into each node of the default directory tree;
a node recording unit configured for dragging a node from a source address to a destination address;
a determining unit configured for determining whether logical relations between the dragged node and the other nodes accord with the logical regulations; and
wherein the content reading unit further configured for generating a rearranged directory tree if the logical relations between the dragged node and the other nodes accord with the logical regulations, and for putting the contents into corresponding nodes of the rearranged directory tree.

2. The system according to claim 1, wherein the determining unit is further configured for sending an error message if the logical relations between the dragged node and other nodes do not accord with the logical regulations.

3. A computer-based method for dynamically presenting a directory tree, the method comprising the steps of:
providing a database for storing a default directory tree with a plurality of node, contents of each node, and logical regulations among the nodes;
reading the contents of each node, and putting the contents into each node of the default directory tree;
dragging a node from a source address to a destination address;
determining whether logical relations between the dragged node and the other nodes accord with the logical regulations;
generating a rearranged directory tree if the logical relations between the dragged node and the other nodes accord with the logical regulations; and
putting the contents into corresponding nodes of the rearranged directory tree.

4. The method according to claim 3, further comprising the step of:
sending an error message if the logical relations between the dragged node and the other nodes do not accord with the logical regulations.
